(19) United States
(12) Patent Application Publication
(10) Pub. No.: US 2025/0220332 A1
(43) Pub. Date: Jul. 3, 2025

(54) HEARING DEVICE COMPONENT WITH ELECTRICAL CABLE OR SOUND TUBE

(71) Applicant: KNOWLES ELECTRONICS, LLC, ITASCA, IL (US)

(72) Inventors: STEPHEN ROYS, WEST CHICAGO, IL (US); DONALD VERGHESE JACOB, CHICAGO, IL (US); CHRISTOPHER MONTI, ELGIN, IL (US); MATTHEW MANLEY, CRYSTAL LAKE, IL (US)

(21) Appl. No.: 18/398,900

(22) Filed: Dec. 28, 2023

(51) Int. Cl. H04R 1/10

(52) U.S. Cl. CPC H04R 1/1033; H04R 1/1058

(57) ABSTRACT

A hearing device component is disclosed. The component includes a housing containing the electrical or mechanical hearing device parts and an opening configured to receive an end portion of an electrical cable assembly, a sound tube or other member. One or more retention members protruding from an inner surface of the opening are configured to mechanically engage the electrical cable assembly, sound tube or other member disposed in the opening and resists movement thereof relative to the opening. The component can be implemented as a RIC unit, BTE unit of BTE electrical connector, among other hearing device components.

### FIELD OF THE DISCLOSURE

The present disclosure relates generally to hearing devices and more particularly to hearing device components comprising an electrical cable assembly or sound tube, and combinations thereof.

### BACKGROUND

Some hearing devices comprise a housing connected to an electrical cable assembly or sound tube. One such hearing device is a receiver-in-canal (RIC) type behind-the-ear (BTE) hearing aid comprising a BTE unit worn against the backside of a user's ear and a RIC unit configured for at least partial insertion in the user's ear canal. An electrical cable assembly interconnects the BTE and RIC units. The BTE unit contains a microphone, electrical circuits and batteries for converting sensed environmental sounds into an amplified electrical audio signal. The RIC unit comprises a balanced armature receiver (also referred to herein as a “receiver”) for converting the electrical audio signal to sound that is emitted into the user's ear canal. One end portion of the electrical cable assembly comprises a connector releasably connectable to the BTE unit. Another end portion of the cable assembly is permanently affixed to the RIC unit. A flange-shaped stopper (also called a “blunt”) is over-molded, flame-formed, or glued onto the end portion of the electrical cable assembly prevents or at least resists rotation of the cable assembly and separation thereof from the RIC unit. In other hearing devices the speaker is located in the BTE unit and sound produced by the speaker propagates to the user's ear via a sound tube connected to the BTE unit, without the need for a RIC unit.

However, the process of adding the flange-shaped stopper is labor intensive and costly. The flanged-shaped stopper also increases the diameter and length of the cable assembly or sound tube. Moreover, this and other mechanisms for fastening the electrical cable assembly to the RIC unit, or sound tube to the BTE unit, have limited robustness and are subject to premature failure. Thus there is an ongoing need for improvements in the art of connecting electrical cable assemblies to hearing device components.

### BRIEF DESCRIPTION OF THE DRAWINGS

The objects, features and advantages of the present disclosure will become more fully apparent upon consideration of the following detailed description and appended claims in conjunction with the accompanying drawings. The drawings depict only representative embodiments and are not considered to limit the scope of the disclosure.

FIG. 1 illustrates a hearing device comprising an in-ear unit and a base unit.

FIG. 2 is a partial sectional view of a representative in-ear unit.

FIG. 3 is an isometric view of a BTE unit electrical connector.

FIG. 4 is a sectional view of an interference fit between an electrical cable assembly or a sound tube and a receptacle portion of a hearing device housing component.

FIG. 5 is an exploded sectional view of a hearing device housing component and a portion of an electrical cable assembly or sound conduit.

FIG. 6 is a partial sectional view of the housing component and cable assembly or sound conduit of FIG. 5 in an assembled state.

FIG. 7 is a partial sectional view of a portion of FIG. 6.

FIG. 8 is an isometric view of an electrical cable assembly or sound conduit receptacle portion of a hearing device component.

FIG. 9 is a partial sectional view of the receptacle portion of FIG. 8 retaining an electrical cable assembly or sound conduit.

FIG. 10 is an isometric view of an alternative electrical cable assembly or sound conduit receptacle portion of a hearing device component.

FIG. 11 is a partial sectional view of the receptacle portion of FIG. 10 retaining an electrical cable assembly or sound conduit.

FIG. 12 is an isometric view of an electrical cable assembly or sound conduit receptacle portion configured as a ferrule for assembly with a hearing device housing component.

FIG. 13 is a partial sectional view of the ferrule of FIG. 12 assembled with a hearing device housing component.

FIG. 14 is an end view of the ferrule of FIG. 12.

FIG. 15 is an isometric view of another electrical cable assembly or sound conduit receptacle portion configured as a ferrule for assembly with a hearing device housing component.

FIG. 16 is a partial sectional view of the ferrule of FIG. 15 retaining an electrical cable assembly or sound conduit.

FIG. 17 is a sectional view of the ferrule of FIG. 15.

FIG. 18 is an isometric view of an electrical cable assembly or sound conduit receptacle portion configured as a ferrule for assembly with a hearing device housing component members.

FIG. 19 is a partial isometric view of an electrical cable assembly or sound conduit receptacle portion comprising a retention member and a stop wall for an electrical cable assembly or a sound conduit.

FIG. 20 is an end view of the receptacle portion of FIG. 19.

FIG. 21 is an end view of a multipart hearing device housing retaining an electrical cable assembly or sound tube.

FIG. 22 is an exploded view of the multipart hearing device housing of FIG. 21.

Those of ordinary skill in the art will appreciate that the drawings are illustrated for simplicity and clarity and therefore may not be drawn to scale and may not include well-known features, that the order of occurrence of actions or steps may be different than the order described, that the order of occurrence of such actions or steps may be performed concurrently unless specified otherwise, and that the terms and expressions used herein have meaning understood by those of ordinary skill in the art except where a different meaning is specifically attributed to them herein.

### DETAILED DESCRIPTION

The disclosure relates generally to hearing devices and hearing device components comprising an electrical cable assembly or sound tube, and more particularly to mechanisms for securely fastening the electrical cable assembly (also referred to herein as an “electrical cable” or “cable”), sound tube or other member to the hearing device or component, and combinations thereof. The component can be part of a receiver-in-canal (RIC) unit, a behind-the-ear (BTE) unit, or an electromechanical BTE connector, among other hearing device components. Representative examples are described further herein.

The hearing device or hearing device component generally comprises a housing containing electrical or mechanical hearing device parts. More specific examples of such parts are described further herein. The housing component comprises an opening configured to receive an end portion of an electrical cable assembly, sound tube or other member. The opening can be an integral part of the housing component or can be part of a multipart housing. Alternatively, the opening can be located in an interface part, such as a ferrule, that is assembled with the housing component. One or more retention members protruding from an inner surface of the opening are configured to mechanically engage the electrical cable assembly, sound tube or other member located in the opening. The one or more retention members resist movement of the electrical cable assembly, sound tube other member relative to the inner surface of the opening when the electrical cable assembly, sound tube or other member is disposed in the opening.

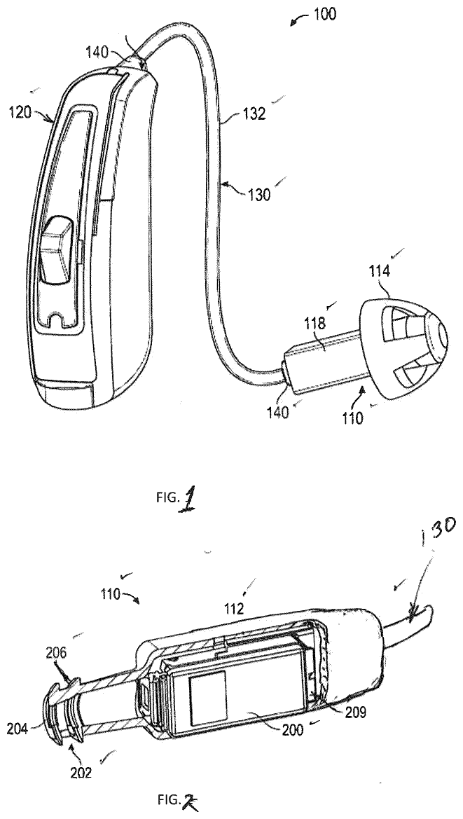

In one implementation, the hearing device component is a receiver-in-canal (RIC) unit comprising a speaker and an electrical cable assembly disposed in the opening of the housing component. The electrical cable assembly is mechanically engaged with one or more retention members protruding from the opening of the housing to resist movement of the electrical cable assembly as described further herein. FIG. 1 illustrates an ear-worn hearing device 100 comprising a RIC unit 110 connected to a BTE unit 120 by an electrical cable assembly 130. A speaker of the RIC unit is acoustically coupled to a sound passage through a nozzle that supports a resilient ear-dome 114 configured for at least partial insertion in a user's ear canal. In FIG. 2, a representative RIC unit comprises a speaker 200 disposed in an external housing 112 integrated with a nozzle 202 having a sound passage 204 and exterior ribs 206 for retaining the ear dome. In FIG. 1, the nozzle supporting the ear dome 114 is integrated directly with a speaker housing 118, without the external housing or other structure encapsulating the speaker housing shown in FIG. 2. In FIG. 1, the electrical cable assembly 130 is connected to a receptacle at an interface 140 of the speaker housing 118, examples of which are described further herein. Eliminating the external housing 112 shown in FIG. 2 reduces the overall size of the in-ear unit.

In FIGS. 1-2, the speaker is implemented as a balanced armature receiver (BAR) for its small size, electrical efficiency and high audio fidelity. A receiver generally comprises one or more motor-actuated diaphragms for emitting sound in response to an electrical signal applied to the motor via the electrical cable assembly. In some implementations, multiple receivers can be acoustically coupled to the nozzle. Alternatively, the speaker can comprise a dynamic driver, a piezoelectric driver, a MEMS electrostatic driver, or any other suitable acoustic driver or a combination of two or more receivers.

The electrical cable assembly can be a preformed shape-retaining flexible member as shown in FIG. 1. Alternatively, the electrical cable assembly can be a non-shape retaining member, or a shape-retaining member deformable by the user for a customized fit. In FIG. 2, the electrical cable assembly comprises one or more electrical conductors disposed within an insulated conduit. The electrical wires can be multi-strand litz wires or other suitable electrical conductors. The electrical wires of the electrical cable assembly are connected to contacts 209 on an electrical interface of the speaker 200. The electrical cable may also comprise a strengthening member. The strengthening member may comprise fibers, such as Kevlar fibers, which are secured to a housing component with an adhesive.

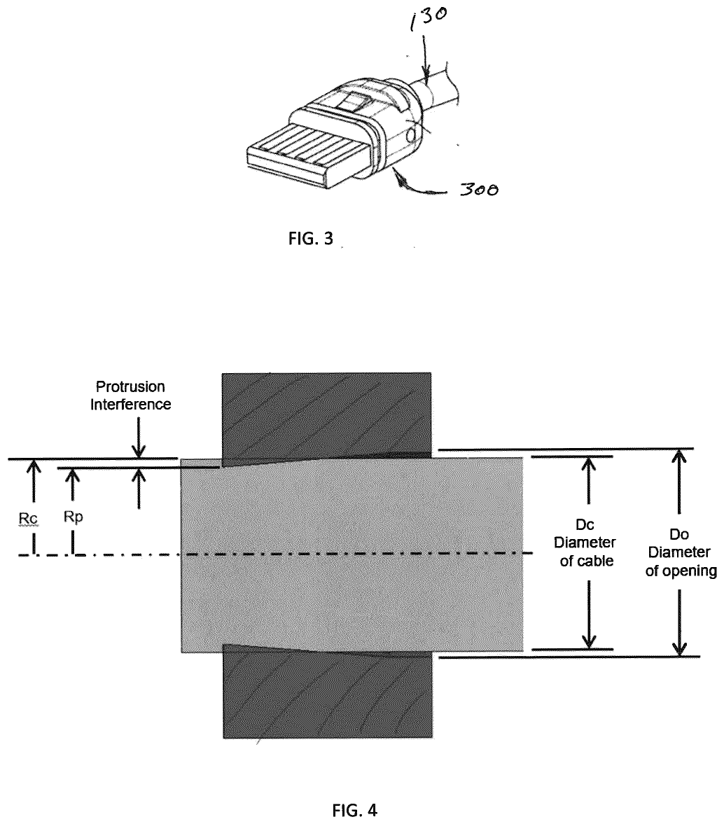

In another implementation, the hearing device component is a BTE electrical connector comprising electrical contacts integrated with a BTE electrical connector housing. An electrical cable assembly disposed in an opening of the BTE electrical connector housing is mechanically engaged with one or more retention members protruding from the opening of the housing to prevent or resist movement of the electrical cable as described further herein. FIG. 3 illustrates a BTE electrical connector 300 connected to an electrical cable assembly 130. The BTE electrical connector is connected or connectable to a BTE unit configured to be worn behind the user's ear, as shown in FIG. 1. Some BTE electrical connectors are releasably connectable to the BTE unit to permit replacement of the RIC unit. The BTE unit generally comprises one or more microphones, audio signal circuitry and batteries, among other circuits and sensors. The BTE unit provides electrical sound signals to the RIC unit via the electrical cable assembly.

In another implementation, the hearing device component is a BTE unit comprising a speaker and a sound tube disposed in an opening of a housing of the BTE unit. The sound tube is mechanically engaged with one or more retention members protruding from the opening of the housing to resist movement of the sound tube as described further herein. The sound tube is shaped to extend from the BTE unit and into the user's ear canal, without a RIC unit. Thus configured, sound is propagated from one or more speakers in the BTE unit to the user's ear canal via the sound tube. The BTE unit connected to a sound tube is similar in overall structure to the hearing device 100 shown in FIG. 1 without the RIC unit 110, wherein the one or more speakers are located in the BTE unit housing instead of a RIC unit.

Generally, one or more retention members protruding from the surface of the opening of the hearing device component provides an interference fit with the electrical cable, sound tube or other member disposed in the opening. The interference necessary to secure the electrical cable, sound tube, or other member in the opening depends generally on the axial and rotational loads that will be applied to the interfering parts, the number of retention members, and materials characteristics of the interfering parts, among other considerations. The housing generally comprises a Young's modulus that is greater than a Young's modulus of the electrical cable assembly, sound tube or other member disposed in the housing. The housing can also generally comprises a yield strength greater than a yield strength of the electrical cable assembly or sound tube.

The interference can be characterized generally as a measure of overlap between interfering parts. In the representative embodiment of FIG. 4, a radial interference is characterized by a difference between a radius R_{C} of the electrical cable assembly, sound tube or other member and a radius R_{P} measured from an axis of the electrical cable, sound tube or other member to the point at which the retention member interferes most with the electrical cable, sound tube, or other member. In the representative hearing device components described herein, the radial interference between each of the one or more retention members and the electrical cable assembly, sound tube or other member can be approximately 0.02 millimeters.

The hearing device component can also comprise clearance between the inner surface of the opening and an outer diameter of the electrical cable assembly or sound tube. The clearance can accommodate deformation of the electrical cable or sound tube. The clearance can also accommodate glue or adhesive to further secure the electrical cable assembly, sound tube or other member in the opening. In the representative embodiment of FIG. 4, the clearance is characterized by a difference between a diameter D_{O} of the opening and a diameter D_{C} of the electrical cable assembly, sound tube or other member. In the representative hearing device components described herein, clearance between the outer diameter of the electrical cable assembly or the sound tube and the inner surface of the opening can be approximately 0.01 millimeters.

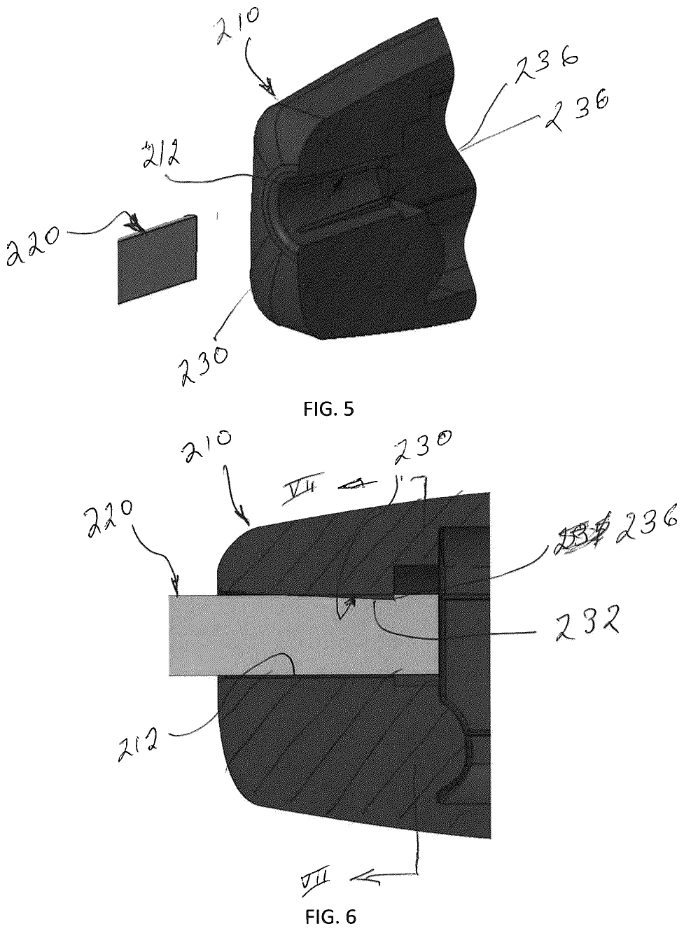

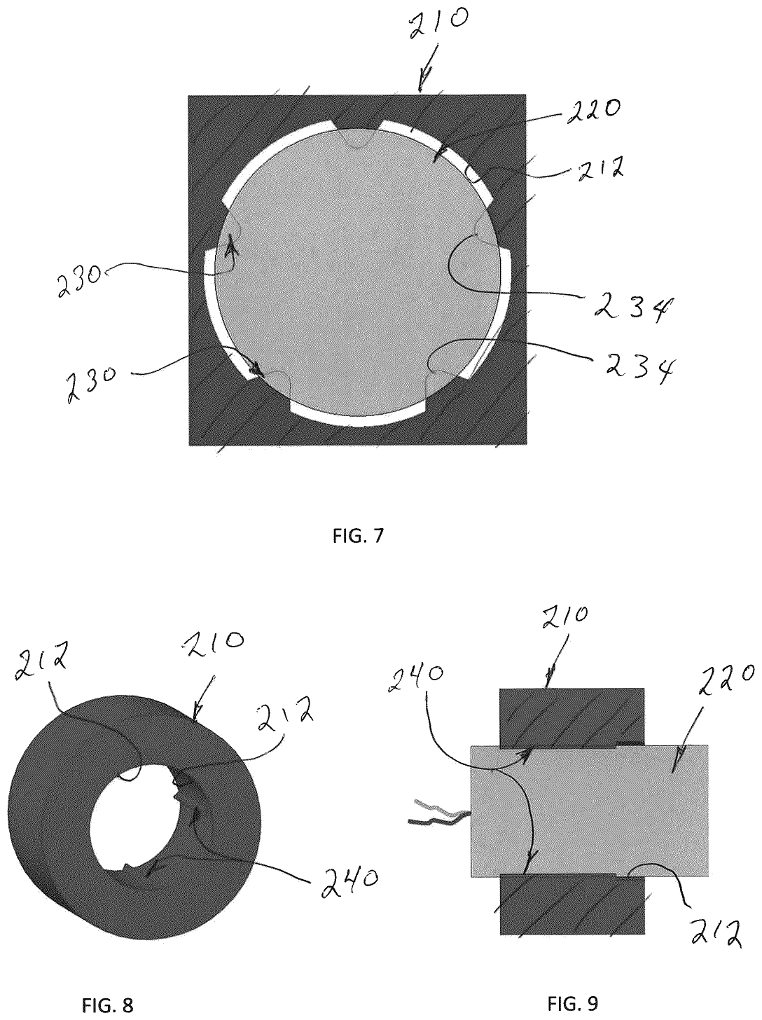

In FIGS. 5-7, an electrical cable assembly or sound tube receptacle portion 210 of a hearing device component comprises an opening 212 into which an electrical cable, sound conduit or other member 220 can be inserted. The representative opening is integrated with a housing component. In other implementations, the opening can be located in a receptacle portion 210 configured as ferrule that is assembled with the housing component and secured thereto by retention features or glue or a combination thereof. Representative ferrules are described further herein. The opening comprises a plurality of retention members 230 aligned with an axis of the opening and protruding from a surface of the opening and comprising a tapered portion 232 having a ridge 234 (shown in FIG. 7). In FIGS. 5-6, the tapered portion comprises a barb defined in part by an edge at an end portion 236 of the tapered portion. Interference between the tapered retention member and the electrical cable, sound tube or other member increases during insertion thereof into the opening. Insertion of the electrical cable or sound tube beyond the barb enables the bard to bite into the electrical cable, sound tube or other member. In FIG. 7, the tapered retention members 230 are spaced equidistant from one another, but the spacing can also be irregular. In FIGS. 6-7, the retention members 230 are shown interfering with the electrical cable, sound tube or other member. The barbs and the ridges generally resist movement of the electrical cable or sound tube relative to the inner surface of the opening. The barbs and ridges can both resist axial and rotational movement. However, the barb may more effectively resist axial movement than the ridge, and the ridge may more effectively resist rotational movement than the barb, depending on the precise configurations thereof.

In FIGS. 8-9, a receptacle portion 210 of a hearing device component comprises a plurality of retention members configured as a plurality of longitudinal ribs 240 protruding from a surface of an opening 212 and aligning with an axis of the opening. The receptacle portion can be an integral part of a hearing device housing component. Alternatively, the receptacle portion can be a ferrule assembled with the housing component. The ribbed retention members 240 are spaced equidistant from one another, but the spacing can also be irregular. In FIG. 9, the ribs are mechanically engaged with an electrical cable assembly, sound tube or other member 220 disposed in the opening 212 and the resulting interference fit prevents relative movement between the electrical cable assembly, sound tube or other member.

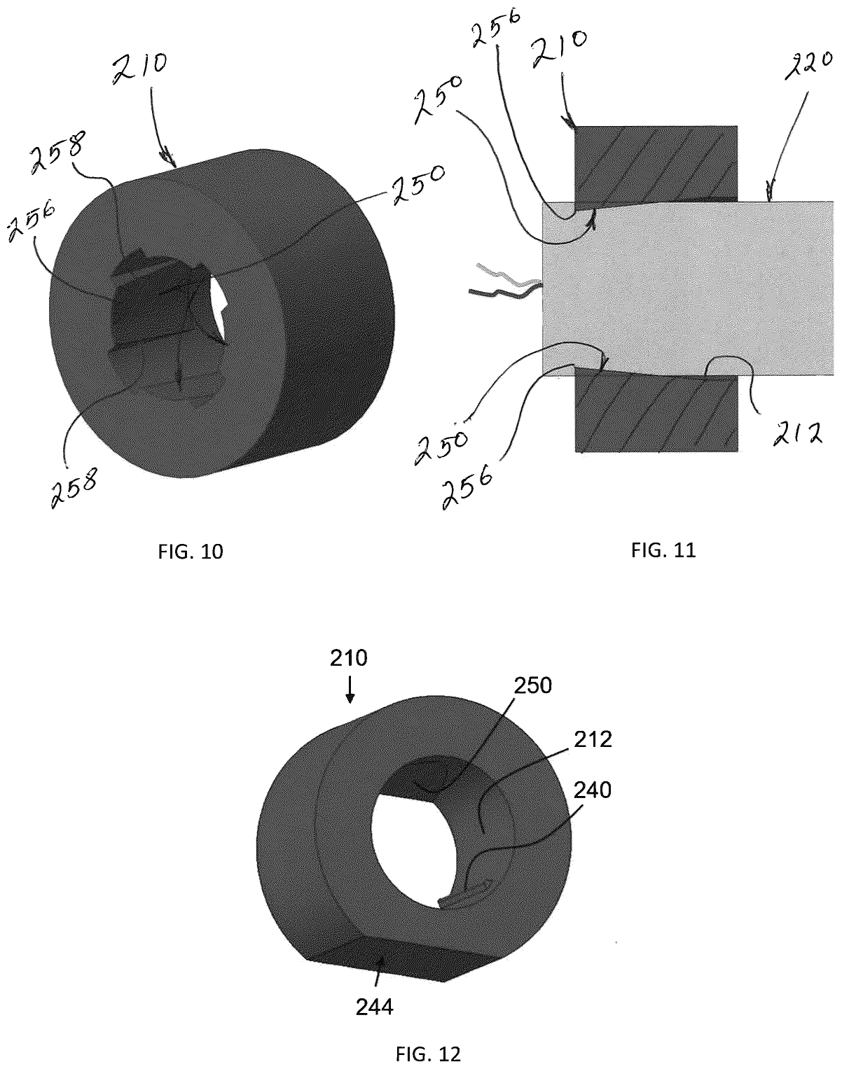

In FIGS. 10-11, a receptacle portion 210 of a hearing device component comprises a plurality of wedge-shaped retention members 250 protruding from a surface of an opening 212. The receptacle portion can be an integral part of a housing component. Alternatively, the receptacle portion can be a ferrule assembled with the housing component. Each retention member 250 comprises a portion reducing an effective diameter of the opening 212 along the axis and a barb defined in part by an edge 256 at an end portion of the retention member. Edges 258 along axial portions of the retention member can also define barbs that increase resistant to rotation. In FIG. 10, the retention members 250 are spaced equidistant from one another, but the spacing can also be irregular. Interference between the wedge-shaped retention members and the electrical cable, sound tube or other member increases during insertion thereof into the opening. Insertion of the electrical cable, sound tube, or other member beyond the barb enables the barb to bite into the electrical cable, sound tube or other member. In FIG. 11, the retention members are mechanically engaged with an electrical cable assembly 220 disposed in the opening 212 and the resulting interference fit prevents movement of the electrical cable assembly, sound tube or other member relative to the opening.

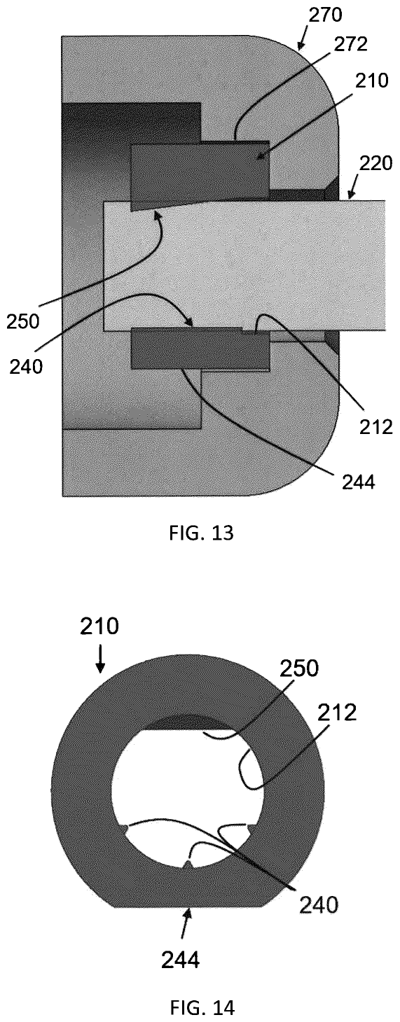

In FIGS. 12-14 and FIG. 18, a receptacle portion 210 of a hearing device component comprises one or more longitudinal rib retention members 240 and one or more wedge-shape retention members 250 protruding from a surface of an opening 212. The receptacle portion 210 can be a ferrule assembled with the housing component as shown in FIG. 13. Alternatively, the receptacle portion can be an integral part of the housing component. In FIG. 14, the retention members are asymmetrically distributed about the opening 212, but can also be arranged symmetrically. In FIG. 18, the retention members 240 and 250 are alternately arranged and symmetrically distributed about the opening 212. The longitudinal rib retention members 240 function similar to the rib retention member of FIGS. 8-9, and the wedge-shaped retention members 250 functions similar to the wedge-shaped retention member of FIGS. 10-11.

In FIG. 13, the receptacle portion 210 is configured as a ferrule for assembly with a housing component 270. The ferrule includes a retention feature configured to securely fasten the ferrule to a housing component 270. The retention feature can be one or one or more flat surfaces 244 or other features that prevent rotational and axial movement of the ferrule relative to the housing. The housing can include an opening 272 having a complementary shape configured for receiving the ferrule. Alternatively, the opening can be an integral part of the housing component without the ferrule.

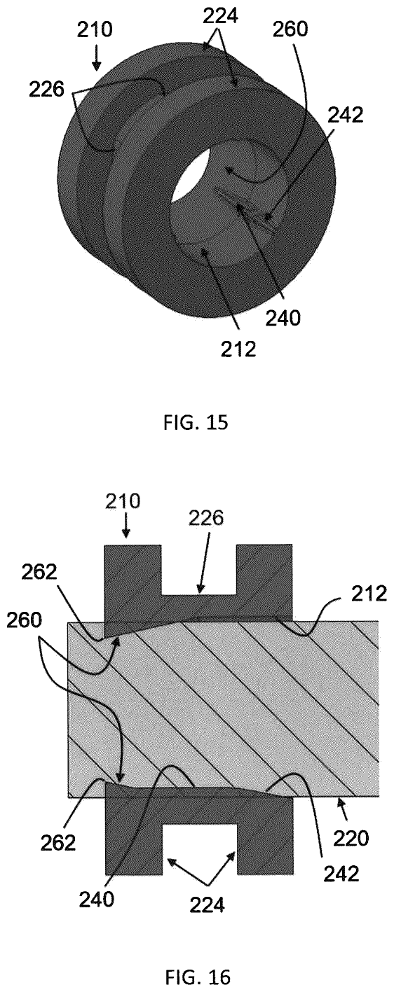

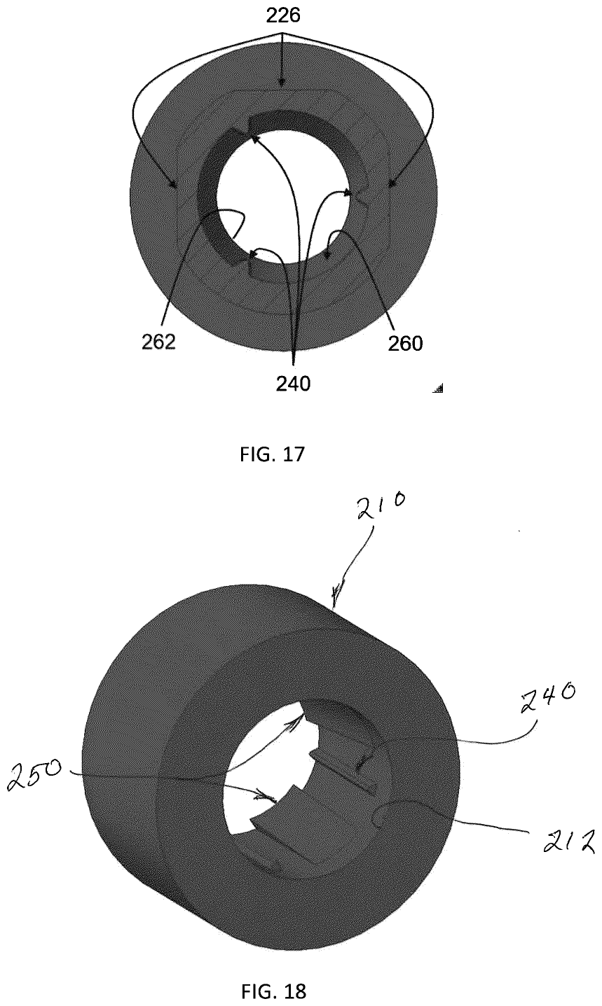

In FIGS. 15-17, a receptacle portion 210 is configured as a ferrule for assembly with a hearing device component. The ferrule comprises one or more longitudinal rib retention members 240 and a continuous annular wedge-shape retention member 260 protruding from a surface of the opening 212. The longitudinal rib retention members 240 have a tapered portion 242 along the axis of the opening and function similar to the retention members of FIGS. 5-9. The annular wedge-shaped retention member comprises a barb defined in part by an edge 262 of the retention member 260. The annular wedge-shaped retention member functions similar to the discrete wedge-shaped retention member of FIGS. 10-11. The ferrule comprises a retention feature configured to securely fasten the ferrule to the housing component. In FIG. 15, the ferrule comprises one or more flat surfaces 226 on a recessed portion between outer flange portions 224. The ferrule can be configured to snap fit into an aperture of the housing component or the housing components can be assembled about the ferrule.

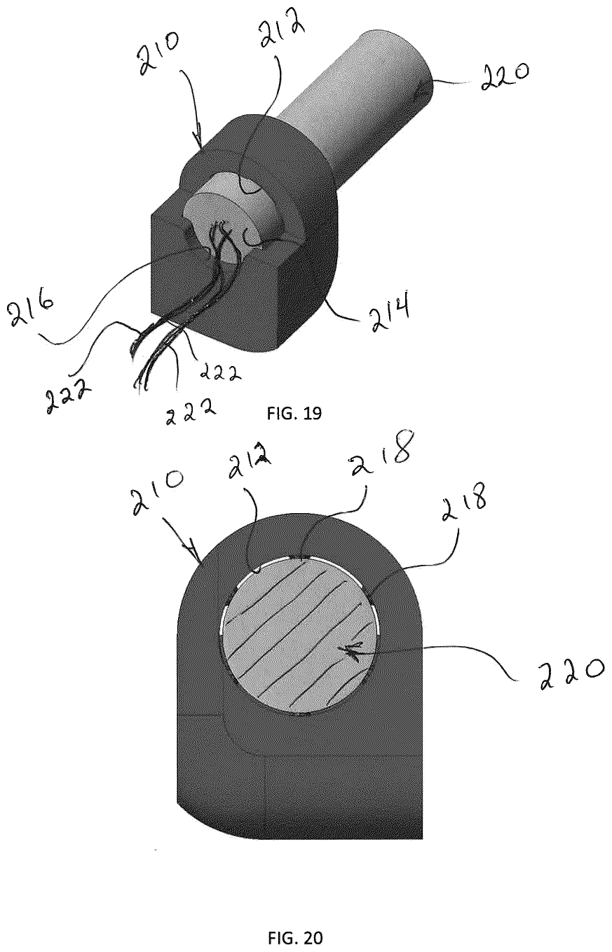

In FIGS. 19-20, a portion 210 of a hearing device component comprises an opening 212 having an end wall 214 with an aperture 216. In FIG. 20, the opening comprises one or more retention members 218 protruding from the surface of the opening and mechanically engaged with an electrical cable assembly, sound tube or other member 220 disposed in the opening to prevent movement thereof relative to the opening. The one or more retention members 218 can be implemented as any one or more of the representative retention members or combinations thereof described herein or illustrated in the drawings, among others. In FIG. 19, an end of the electrical cable assembly abuts against the end wall 214 of the opening when the electrical cable assembly is fully inserted into the opening. The end wall positively locates the electrical cable assembly in the opening and can ensure that the electrical cable assembly is inserted sufficiently into the opening for proper mechanical engagement (e.g., with barbs of the retention members). Electrical wires 222 of the electrical cable assembly can extend through the aperture of the end wall 214. More generally, the electrical cable assembly 220 can be a sound tube or other member disposed in the opening. A conduit of a sound tube can be aligned with the aperture 216 of the end wall 214. In BTE units comprising a speaker, the aperture 216 can be acoustically coupled to the conduit of the sound tube, through which sound produced by a speaker propagates.

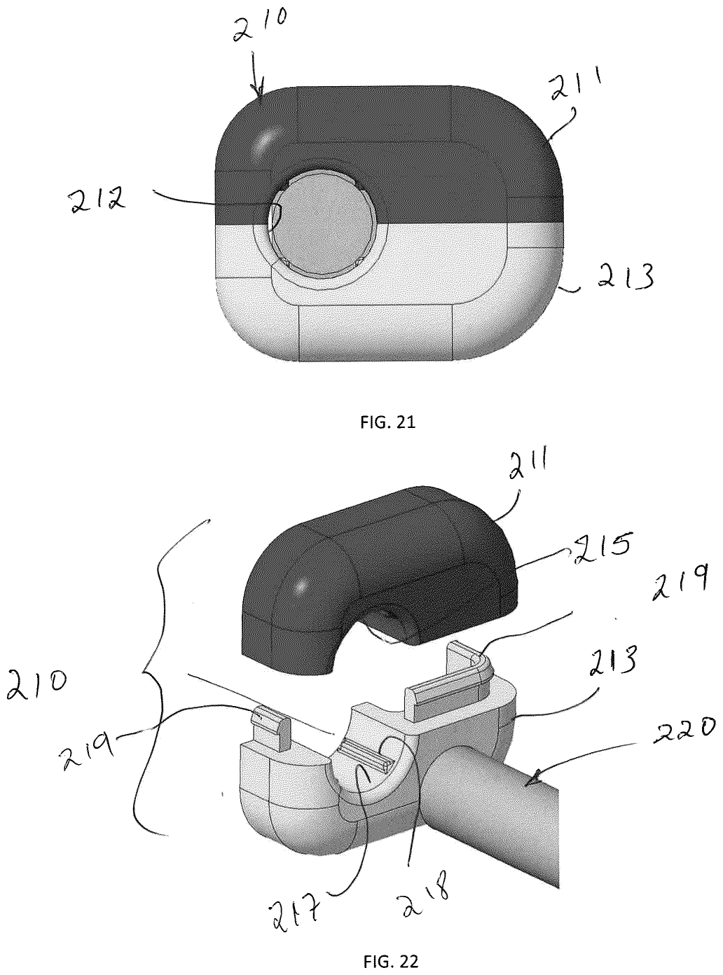

In FIG. 21-22, a, hearing device component 210 comprises first and second housing portions 211 and 213 fastened together by complementary snap-fitting members. In FIG. 22, the opening 212 is at least partially defined by a first partial opening 215 of the first housing portion 211 and a second partial opening 217 of the second housing portion 213 when the first and second housing portions are fastened together. One or more retention members protruding from a surface of the opening can be implemented as any one or more of the representative retention members or combinations thereof described herein or illustrated in the drawings, among others. The electrical cable assembly, sound tube or other member 220 can be inserted into the first and second partial openings during assembly of the first and second housing portions and captured by the retention members. The complementary snap-fitting members comprise protrusions 219 on the second housing portion 213 that fit into complementary recesses on the first housing portion 211. The protrusion can be retained therein by an interference fit, epoxy, weld or other means. In other implementations, other types of snap-fitting members can be employed.

While the disclosure and what is presently considered to be the best mode thereof has been described in a manner establishing possession and enabling those of ordinary skill in the art to make and use the same, it will be understood and appreciated that there are many equivalents to the representative embodiments described herein and that myriad modifications and variations may be made thereto without departing from the scope and spirit of the invention, which is to be limited not by the embodiments described, but by the appended claims and their equivalents.

What is claimed is:

1. A hearing device component comprising:
electrical or mechanical hearing device parts;
a housing containing the electrical or mechanical hearing device parts, the housing comprising:
an opening configured to receive an end portion of an electrical cable assembly, sound tube or other member;
a retention member protruding from an inner surface of the opening, the retention member configured to mechanically engage the electrical cable assembly, sound tube or other member disposed in the opening,
wherein the retention member mechanically resists movement of the electrical cable assembly, sound tube or other member relative to the housing when the electrical cable assembly, sound tube or other member is disposed in the opening.

2. The hearing device component of claim 1 further comprising clearance between an outer diameter of the electrical cable assembly, sound tube or other member and the inner surface of the opening, wherein the retention member is configured to provide radial interference with the electrical cable assembly, sound tube or other member disposed in the opening.

3. The hearing device component of claim 2 further comprising a ferrule fastened to the housing, wherein the opening is disposed in the ferrule.

4. The hearing device component of claim 1, the housing comprising a Young's modulus greater than a Young's modulus of the electrical cable assembly, sound tube or other member.

5. The hearing device component of claim 1, the housing comprising a yield strength greater than a yield strength of the electrical cable assembly, sound tube or other member.

6. The hearing device component of claim 1, the retention member comprising a tapered portion having a ridge aligned with an axis of the opening, the tapered portion including a barb, wherein the barb resists movement of the electrical cable assembly, sound tube or other member relative to the opening.

7. The hearing device component of claim 1, the retention member comprising a rib aligned with an axis of the opening, wherein the rib resists rotation of the electrical cable assembly, sound tube or other member relative to the opening.

8. The hearing device component of claim 1, the retention member comprising a wedge-shaped portion aligned with an axis of the opening, the wedge-shaped portion comprising a portion reducing an effective diameter of the opening, the wedge-shaped portion comprising a barb mechanically engageable with the electrical cable assembly, sound tube or other member upon insertion thereof into the opening.

9. The hearing device component of claim 1, the opening of the housing comprising an end wall having an aperture, wherein an end of the electrical cable assembly or sound tube abuts against the end wall of the opening when the electrical cable assembly, sound tube or other member is fully inserted into the opening.

10. The hearing device component of claim 1, the housing is an assembly comprising first and second housing portions fastened together, the opening at least partially defined by a first partial opening of the first housing portion and a second partial opening of the second housing portion when the first and second housing portions are fastened together.

11. The hearing device component of claim 1 is a receiver-in-canal (RIC) unit comprising a speaker and an electrical cable assembly disposed in the opening of the housing and mechanically engaged with the retention member.

12. The hearing device component of claim 1 is a behind-the-ear (BTE) connector comprising electrical contacts integrated with the housing and an electrical cable assembly disposed in the opening of the housing, the electrical cable assembly mechanically engaged with the retention member.

13. The hearing device component of claim 1 is a behind-the-ear (BTE) unit comprising a speaker and a sound tube disposed in the opening of the housing and mechanically engaged with the retention member.

14. A hearing device comprising:
a receiver-in-canal component comprising a housing acoustically coupled to a nozzle configured for at least partial insertion in a user's ear canal, the housing comprising:
an opening with an inner surface;
a retention member protruding from the inner surface of the opening;
an electrical cable assembly comprising an end portion disposed in the opening of the housing and mechanically engaged with the retention member,
wherein the retention member resists movement of the electrical cable assembly relative to the housing.

15. The hearing device of claim 14 further comprising a radial interference of 0.02 millimeters or more between the electrical cable assembly and the retention member protruding from the inner surface of the opening, wherein the inner surface of the opening comprises a cylindrical portion.

16. The hearing device of claim 15 further comprising a clearance of 0.01 millimeters or more between an outer diameter of the electrical cable assembly and the inner surface of the opening, wherein the inner surface of the opening comprises a cylindrical portion.

17. The hearing device of claim 14, the retention member comprising a tapered portion having a ridge aligned with an axis of the opening, the tapered portion including a barb, wherein the barb bites into the electrical cable assembly and resists movement of the electrical cable assembly relative to the opening.

18. The hearing device of claim 14, the retention member comprising a rib aligned with an axis of the opening, wherein the rib resists rotation of the electrical cable assembly relative to the opening.

19. The hearing device of claim 14, the retention member comprising a wedge-shaped portion aligned with an axis of the opening, the wedge-shaped portion comprising a portion reducing an effective diameter of the opening, the wedge-shaped portion comprising a barb mechanically engageable with the electrical cable assembly upon insertion thereof into the opening.

20. The hearing device of claim 14, the opening of the housing comprising an end wall having an aperture, wherein an end of the electrical cable assembly abuts against the end wall of the opening when fully inserted into the opening and a portion of the electrical cable assembly extends through the aperture of the end wall.

21. The hearing device of claim 14, the housing is an assembly comprising first and second housing portions fastened together, the opening at least partially defined by a first partial opening of the first housing portion and a second partial opening of the second housing portion when the first and second housing portions are fastened together, wherein the electrical cable assembly can be inserted in the first and second partial openings during assembly of the first and second housing portions.

22. The hearing device of claim 14, the housing comprising a ferrule comprising a retention feature, the opening disposed in the ferrule, wherein the ferrule is fastened to the housing.
